(19) United States
(12) Patent Application Publication
(10) Pub. No.: US 2024/0131744 A1
(43) Pub. Date: Apr. 25, 2024

(54) SAWING APPARATUS AND ELECTRICAL ROTARY FEEDTHROUGH FOR A TOOL, IN PARTICULAR FOR A SAWING APPARATUS

(71) Applicant: Festool GmbH, Wendlingen (DE)

(72) Inventors: Stefan TULODZIECKI, Neuhausen (DE); Benjamin Allgaier, Roemerstein (DE); Philipp Kranz, Munningen (DE); Marius Heckenberger, Stuttgart (DE); Alexander Lautenschläger, Esslingen (DE)

(73) Assignee: Festool GmbH, Wendlingen (DE)

(21) Appl. No.: 18/491,371

(22) Filed: Oct. 19, 2023

(30) Foreign Application Priority Data
Oct. 19, 2022 (DE) 10 2022 211 130.3

(51) Int. Cl. B27B 5/38

(52) U.S. Cl. CPC B27B 5/38

(57) ABSTRACT

A sawing apparatus can have a drive shaft that is rotatable about a central axis for rotationally driving a saw blade. The apparatus includes an electrical rotary feedthrough for the electrically conductive connection of the drive shaft to a connection assembly. The electrical rotary feedthrough includes a first component having a contact section that tapers in the direction of a second component and the shell surface of said contact section forms a first contact surface. The second component has a receiving channel that extends along the central axis and the side surface of the receiving channel forms a second contact surface. The first contact surface lies against the second contact surface in sections. The receiving channel and the tapering contact section has a clearance for ruling out a purely axial abutment of the components. In addition, an electrical rotary feedthrough for a sawing apparatus, is described.

### CROSS-REFERENCE TO RELATED APPLICATIONS

This application claims priority to German Application No. 10 2022 211 130.3 filed on Oct. 20, 2022, the content of which is hereby incorporated by reference in its entirety.

### BACKGROUND OF THE INVENTION

### Field of the Invention

The invention relates to a sawing apparatus having a drive shaft that is rotatable about a central axis for rotationally driving a saw blade. The sawing apparatus further comprises a base part on which the drive shaft is rotatably mounted. In addition, the sawing apparatus has an electrical rotary feedthrough for the electrically conductive connection of the drive shaft to a connection assembly. The connection assembly is fastened to the base part. The electrical rotary feedthrough comprises a first component, which is arranged coaxially in relation to the central axis, and a second component that is arranged coaxially in relation to the central axis.

In addition, the invention relates to an electrical rotary feedthrough for a tool, in particular for a sawing apparatus and in particular for the electrically conductive connection of a drive shaft, which can rotate about a central axis, to a connection assembly that is fixed relative to the drive shaft. The electrical rotary feedthrough comprises a first component and a second component that are arranged coaxially in relation to a central axis.

### Description of Related Art

Sawing apparatuses of this type and electrical rotary feedthroughs are known from the prior art. The electrical rotary feedthroughs are used, by way of example, to supply sensors, which are connected to the drive shaft, with electrical current and/or electrical voltage. Likewise, the electrical rotary feedthroughs can be used to route sensor signals that are generated by means of sensors, which are connected to the drive shaft, to a connection assembly that is fastened to the non-rotatable base part. Such sensors are used, by way of example, for contact detection, in other words for determining whether a saw blade that is connected to the drive shaft is touched in an undesirable manner by a user of the sawing apparatus or such contact is threatened. In this context, the saw blade itself can be designed as a sensor. An emergency braking unit can be activated on the basis of the contact detection.

### SUMMARY OF THE INVENTION

The object of the present invention is to further improve electrical rotary feedthroughs and sawing apparatuses that are equipped with said electrical rotary feedthroughs. In particular, the electrical rotary feedthroughs are to be improved in terms of the reliability of the signal transmission, in other words the reliability of the transmission of electrical current, electrical voltage and/or a sensor signal.

The object is achieved by a sawing apparatus having a drive shaft that is rotatable about a central axis for rotationally driving a saw blade. The sawing apparatus further comprises a base part on which the drive shaft is rotatably mounted. In addition, the sawing apparatus has an electrical rotary feedthrough for the electrically conductive connection of the drive shaft to a connection assembly. The connection assembly is fastened to the base part. The electrical rotary feedthrough comprises a first component, which is arranged coaxially in relation to the central axis, and a second component that is arranged coaxially in relation to the central axis. The first component comprises a contact section that tapers in the direction of the second component and along the central axis and the shell surface of said contact section forms a first contact surface.

The second component comprises a receiving channel that extends along the central axis and the side surface of the receiving channel forms a second contact surface. In this case, the first contact surface lies against the second contact surface at least in sections. In addition, the receiving channel and/or the tapering contact section comprises a clearance for ruling out a purely axial abutment of the first component against the second component. Since the first contact section tapers in the direction of the second component, the first contact section is slimmer at an end that faces the second component than at an end that faces away from the second component. The shell surface is therefore to be understood as an outer surface of the contact section, the surface normal of which having at least one extent component in a radial direction in relation to the central axis. The receiving channel is preferably closed on one side. This means that the receiving channel extends into the second component from an opening that faces the first component. The side surface of the receiving channel in this case is to be understood to mean a delimiting surface of the receiving channel, the surface normal of which having at least one extent component in a radial direction in relation to the central axis. In the case of such a sawing apparatus, an electrically conductive contact between the first contact surface and the second contact surface is maintained with a high degree of reliability. In this case, the contact is a line contact or a surface contact. In this context, the clearance means that the contact between the first contact surface and the second contact surface always has an axial component and a radial component in relation to the central axis. A purely axial abutment of the first component against the second component is thus ruled out. An electrically conductive contact of consistently high quality is consequently maintained even if there should be undesired relative movements, for example, tilting, between the first component and the second component. In addition, the reliable abutment of the first contact surface against the second contact surface has a cleaning effect. The first contact surface and the second contact surface are mechanically cleaned due to the combination of this abutment and its relative rotation. This is also conducive to reliable electrical contact. In addition, the reliable contacting between the first contact surface and the second contact surface causes a high signal-to-noise ratio. In the event that a sensor signal is transmitted by means of the electrical rotary feedthrough, this is therefore performed in high quality. In the event that the electrical rotary feedthrough is used for power supply or voltage supply, this power supply or voltage supply is particularly reliable.

### BRIEF DESCRIPTION OF THE DRAWINGS

The invention is explained below with reference to various exemplary embodiments that are illustrated in the attached drawings. In the drawings:

FIG. 1 illustrates a sawing apparatus in accordance with the invention having an electrical rotary feedthrough in accordance with the invention in a schematic view,

FIG. 2 illustrates the rotary feedthrough of the sawing apparatus from FIG. 1 in a sectional detail view, wherein the rotary feedthrough is embodied in accordance with a first embodiment,

FIG. 3 illustrates the rotary feedthrough in accordance with the invention in accordance with a second embodiment,

FIG. 4 illustrates the rotary feedthrough in accordance with the invention in accordance with a third embodiment,

FIG. 5 illustrates the rotary feedthrough in accordance with the invention in accordance with a fourth embodiment,

FIG. 6 illustrates the rotary feedthrough in accordance with the invention in accordance with a fifth embodiment, and

FIG. 7 illustrates the rotary feedthrough in accordance with the invention in accordance with a sixth embodiment.

### DETAILED DESCRIPTION OF THE INVENTION

The tapering contact section can be conical in shape. This includes a variant in which the contact section is shaped like a cone. In addition, this includes a variant in which the contact section is shaped like a truncated cone.

Alternatively, the tapering contact section can have a convex curved outer surface. By way of example, the contact section is designed in the shape of a spherical section. In another example, the contact section is embodied as a convex shaped section of a torus. The contact section therefore tapers with a constant radius. Of course, other convex curvatures are also possible, in particular those that result from a rotation of a line that is convex curved at least in sections. By way of example, a radius of curvature can increase or decrease in the direction of the second component.

In a further alternative, the tapering contact section has a concave curved outer surface. By way of example, the contact section is embodied as a concave shaped section of a torus. Of course, other concave curvatures are also possible, in particular those that result from a rotation of a line that is concave curved at least in sections. By way of example, a radius of curvature can increase or decrease in the direction of the second component.

The receiving channel of the second component can likewise taper in the same direction as the contact section, at least in sections. In this configuration, planar contact between the first contact surface and the second contact surface can be reliably enabled.

In the case of the electrical rotary feedthrough of the sawing apparatus, the first component can be arranged on the base part, in other words can be non-rotating, and the second component can be arranged on the drive shaft, in other words can be rotating or at least rotatable. The reverse is also possible.

The drive shaft can also comprise a flange that is designed to connect a saw blade to the drive shaft. In this case, the saw blade is driven by means of the drive shaft via the flange.

The sawing apparatus can be a machine that can be operated independently of the mains. The sawing apparatus can thus comprise an electrical energy storage device in which energy is stored that is used to drive the drive shaft. In other words, it is a battery-operated or rechargeable battery-operated sawing apparatus. For such sawing apparatuses, the reliable and high-quality contacting of the first contact surface and the second contact surface is of particular importance, since in the case of such sawing apparatuses, there is usually no common electrical potential, in other words no earth potential or zero potential.

In one variant, the side surface comprises a surface section in the shape of a truncated cone shell. The surface section in the shape of a truncated cone forms the second contact surface. It is understood that each surface section in the shape of a truncated cone can be used as a second contact surface. By way of example, the second contact surface is embodied as a chamfer at the inlet of the receiving channel. The side surface therefore has an extent component in the axial direction and in the radial direction. The second contact surface can thus be contacted in a simple and reliable manner by the first contact surface.

In another variant, the side surface comprises a convex curved surface section. The convex curved surface section forms the second contact surface. It is understood that each convex curved surface section can be used as a second contact surface. By way of example, the convex curved surface section is realised as a radius at the edge of the inlet opening or as a rounded edge at the edge of the inlet opening. The side surface therefore has an extent component in the axial direction and in the radial direction. The second contact surface can thus be contacted easily and reliably by the first contact surface.

The tapering contact section and/or the receiving channel can be rotationally symmetrical at least in sections in relation to the central axis. The electrical rotary feedthrough thus has only a comparatively low mechanical rotational resistance. It is therefore easy to rotate. At the same time, the electrical contact between the first contact surface and the second contact surface is reliably maintained.

In a case in which the second contact surface is embodied as a convex curved, rotationally symmetrical surface section, this can also be referred to as trumpet-shaped.

In one embodiment, the first component and the second component are spring-loaded against one another by means of a spring element. The first contact surface and the second contact surface thus lie against one another with a particularly high degree of reliability. This applies in particular even if the electrical rotary feedthrough is subject to vibrations or shocks. In this context, it is possible both for the first component to be acted upon by means of a spring element in the direction of the second component, and for the second component to be acted upon by means of a spring element in the direction of the first component. The spring element can therefore be assigned to each of the first component and the second component. It is also conceivable for a spring element to be assigned to both the first component and the second component. In all variants, the spring loading takes place along the central axis of the drive shaft.

The spring element can comprise a cylindrical or conically wound helical spring. A cylindrically wound helical spring has the advantage that it can be produced easily and cost-effectively. In addition, such a helical spring can be easily guided, for example along its central axis. A conically wound helical spring has the advantage that it allows only a small lateral deflection in relation to its central axis. A contact of the spring element with components that are arranged in an environment of the spring element, for example a sleeve, can consequently be avoided.

The spring element is preferably guided in a sleeve. The sleeve is preferably made of a metal material, for example steel. As a result, the sleeve comprises a comparatively high abrasion resistance. The sleeve is thus durable and can reliably guide the spring element over a long period of time.

In one embodiment, the sleeve comprises a first section having a first inner diameter and a second section having a second inner diameter. The second inner diameter is larger than the first inner diameter. The second section faces the first component or second component to be acted upon. The spring element is always guided precisely and reliably, in particular by means of the first section. Due to the fact that the second section has a larger inner diameter, the spring element in this region does not touch the sleeve at all or only to a lesser extent when it moves transversely to the central axis of the spring. In this manner, undesired collisions between the spring element and the sleeve are thus avoided. This reduces the abrasion on these two components.

In one example, the transition between the first section and the second section is designed as a chamfer or radius. Alternatively or additionally, a chamfer or a radius is provided at the end of the second section that faces the first component or the second component.

The clearance can be formed by means of a free space for the contactless reception of an end section of the first component that faces the second component. The clearance is thus formed by means of a section of the second component in which no material is present. The clearance is formed, by way of example, by means of a depression, recess, a void or another suitable free space. An end section of the first component is received therein without touching the second component in this region. In this manner, purely axial contact between the first component and the second component is avoided in a particularly simple and reliable manner.

In this case, it is possible for the free space to be formed by means of a cylindrical section of the receiving channel, which lies on a side of the second contact surface that faces away from the first component. The cylindrical section is designed, by way of example, as a bore or as a recess. Such a free space can be produced particularly easily and efficiently.

The clearance can also be formed by means of a void of an end section of the first component that faces the second component. The clearance is thus arranged on the first component. The a void can be produced by removing material from the first component in this region during the production of the first component. Alternatively, it is possible not to arrange any material at all in the region of the void in the course of the production of the first component. The void is designed, for example, as a flattening or a rounding. Such a void not have any material can be produced in a particularly simple and efficient manner.

In one embodiment, the second component is formed by means of an end section of the drive shaft, and the receiving channel is arranged in the drive shaft. Alternatively, the second component is formed by means of an element of the connection assembly, and the receiving channel is arranged in the element of the connection assembly. In both variants, the electrical rotary feedthrough is integrated into the sawing apparatus in a space-saving manner. In addition, in this manner only a few additional components are required for the electrical rotary feedthrough.

In one variant, the second component comprises an insert, and the receiving channel is arranged in the insert. This has the advantage that the insert can be produced from a material that is particularly suitable for the electrical rotary feedthrough. In particular, a material having good wear properties and good electrical contacting properties is selected for this purpose. This can take place essentially irrespectively of a surrounding material of the drive shaft. In this manner, it is possible to create a powerful electrical rotary feedthrough.

In one example, the insert comprises a graphite material, for example graphite wool. In particular, the insert is produced from graphite wool.

The insert can be connected to the end section of the drive shaft or the element of the connection assembly via a positive-locking connection that acts along the central axis. Consequently, the insert is reliably connected to the end section of the drive shaft or the element of the connection assembly. The positive-locking connection comprises, by way of example, a thread. Such a positive locking connection can be produced particularly efficiently.

In addition, the object is achieved by an electrical rotary feedthrough for a tool, in particular for a sawing apparatus and in particular for the electrically conductive connection of a drive shaft, which can rotate about a central axis, to a connection assembly that is fixed relative to the drive shaft. The electrical rotary feedthrough comprises a first component and a second component that are arranged coaxially in relation to a central axis. In this case, the first component comprises a contact section that tapers in the direction of the second component and along the central axis and the shell surface of said contact section forms a first contact surface. The second component comprises a receiving channel that extends along the central axis and the side surface of the receiving channel forms a second contact surface. The first contact surface lies against the second contact surface at least in sections. The receiving channel and/or the contact section comprises a clearance for excluding a purely axial abutment of the first component against the second component. The sawing apparatus is in particular a sawing apparatus in accordance with the invention. Since the first contact section tapers in the direction of the second component, the first contact section is slimmer at an end that faces the second component than at an end that faces away from the second component. The shell surface is therefore to be understood as an outer surface of the contact section, the surface normal of which having at least one extent component in a radial direction in relation to the central axis. The receiving channel is preferably closed on one side. This means that the receiving channel extends into the second component from an opening that faces the first component. The side surface of the receiving channel in this case is to be understood to mean a delimiting surface of the receiving channel, the surface normal of which having at least one extent component in a radial direction in relation to the central axis. In the case of such an electrical rotary feedthrough, an electrically conductive contact between the first contact surface and the second contact surface is maintained with a high degree of reliability. In this case, the contact is a line contact or a surface contact. In this context, the clearance means that the contact between the first contact surface and the second contact surface always has an axial component and a radial component in relation to the central axis. A purely axial abutment of the first component against the second component is thus ruled out. An electrically conductive contact of consistently high quality is consequently maintained even if there should be undesired relative movements, for example, tilting, between the first component and the second component. In addition, the reliable abutment of the first contact surface against the second contact surface has a cleaning effect. The first contact surface and the second contact surface are mechanically cleaned due to the combination of this abutment and its relative rotation. This is also conducive to reliable electrical contact. In addition, the reliable contacting between the first contact surface and the second contact surface causes a high signal-to-noise ratio. In the event that a sensor signal is transmitted by means of the electrical rotary feedthrough, this is therefore performed in high quality. In the event that the electrical rotary feedthrough is used for the power supply or voltage supply, this power supply or voltage supply is particularly reliable.

It is understood that the features, effects and advantages of the electrical rotary feedthrough that are mentioned in connection with the sawing apparatus in accordance with the invention also apply to the electrical rotary feedthrough as such. The aforementioned examples and variants can thus be combined, regardless of whether they are mentioned in connection with the sawing apparatus in accordance with the invention or the electrical rotary feedthrough in accordance with the invention.

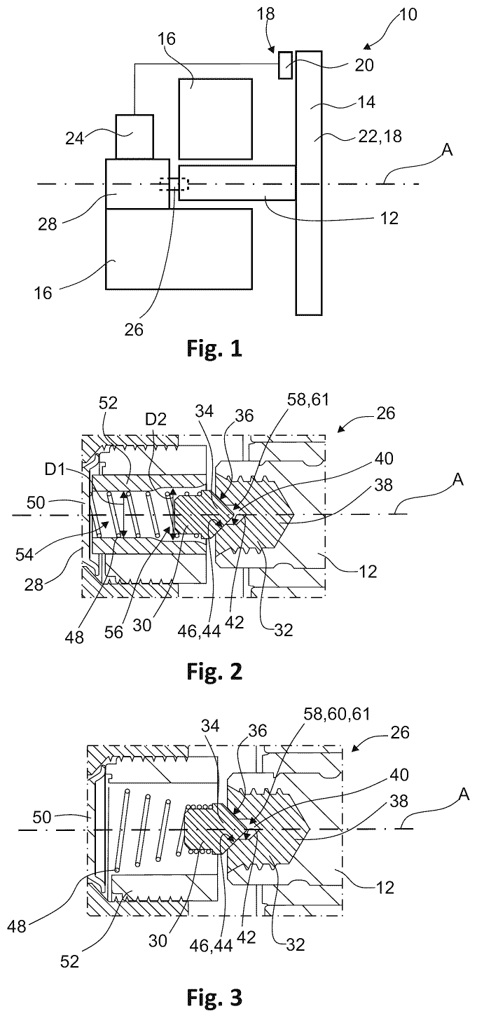

FIG. 1 illustrates a sawing apparatus 10.

This comprises a drive shaft 12 that is rotatable about a central axis A.

A circular disk-shaped saw blade 14 is fastened to the drive shaft 12. This saw blade can be driven in a rotary manner by means of the drive shaft 12.

The drive shaft 12 and thus also the saw blade 14 are rotatably mounted on a base part 16.

The sawing apparatus 10 further comprises an emergency braking unit 18, by means of which the saw blade 14 can be brought to a standstill if it is touched in an undesirable manner by a user of the sawing apparatus 10 or such contact is threatened.

The emergency braking unit 18 comprises a braking apparatus 20 that is designed to brake the saw blade 14 to a standstill, if necessary.

In addition, the emergency braking unit 18 comprises a sensor apparatus 22 that is embodied so as to detect an actual or threatening contact of the user with the saw blade 14.

In the present example, the saw blade 14 is not only used for material processing, but is also embodied as a capacitive sensor. In this respect, the saw blade 14 represents a component of the sensor apparatus 22.

The emergency braking unit 18 further comprises a control unit 24 that is coupled to both the sensor apparatus 22 and the braking apparatus 20. The control unit 24 is embodied so as to activate the braking apparatus 20 as soon as an actual or imminent contact of the user with the saw blade 14 has been detected by means of the sensor apparatus 22.

In order for the saw blade 14 to act as a capacitive sensor, it must be supplied with an electrical voltage.

In order to make this possible, the sawing apparatus 10 comprises an electrical rotary feedthrough 26, which is also referred to below simply as a rotary feedthrough 26.

The electrical rotary feedthrough 26 is electrically arranged between the drive shaft 12 and a connection assembly 28. In this manner, since the saw blade 14 is electrically conductively connected to the drive shaft 12, the saw blade 14 can be electrically connected to the connection assembly 28.

The connection assembly 28 is fastened to the base part 16, in other words it does not rotate.

The rotary feedthrough 26 is illustrated in detail in FIG. 2.

The rotary feedthrough comprises a first component 30, which is arranged coaxially in relation to the central axis A. This first component is arranged on the connection assembly 28 and consequently does not rotate.

In the illustrated embodiment, the first component 30 is embodied as a rotationally symmetrical, mushroom-shaped component. In the broadest sense, the first component 30 can also be referred to as pin-shaped.

The first component 30 comprises a contact section 34 that tapers in the direction of a second component 32 that will be explained in more detail below.

The contact section 34 also tapers along the central axis A.

In the embodiment in accordance with FIG. 2, the contact section 34 is embodied as a cone that is rotationally symmetrical in relation to the central axis A. The tip of the cone points in the direction of the second component 32.

The shell surface of the contact section 34, in other words the shell surface of the cone, forms a first contact surface 36.

The second component 32 is formed by means of an end section of the drive shaft 12.

More precisely, the second component 32 comprises an insert 38 that is fastened in the end of the drive shaft 12 via a thread. The insert 38 is therefore connected to the end section of the drive shaft 12 in a positive-locking manner along the central axis A.

In this case, the insert 38 is arranged coaxially in relation to the central axis A.

A receiving channel 40 is likewise positioned coaxially in relation to the central axis A in the insert 38. The receiving channel 40 thus extends along the central axis A. In addition, the receiving channel 40 is rotationally symmetrical in relation to the central axis A.

A side surface 42 of the receiving channel 40 forms a second contact surface 44.

More precisely, the side surface 42 comprises a surface section 46 in the shape of a truncated cone shell. This is embodied as a second contact surface 44.

In the embodiment that is illustrated in FIG. 2, the surface section 46 in the shape of a truncated cone shell can also be regarded as a chamfer at the inlet of the receiving channel 40.

In the illustrated exemplary embodiment, the angle at which the first contact surface 36 is inclined in relation to the central axis A and the angle at which the second contact surface 44 is inclined in relation to the central axis A are essentially the same. The first contact surface 36 and the second contact surface 44 thus lie flat against one another.

In addition, the rotary feedthrough 26 comprises a spring element 48, which is arranged under tension between the first component 30 and a base body 50 of the connection assembly 28.

The first component 30 and the second component 32 are thus spring-loaded against one another by means of the spring element 48.

In the embodiment in accordance with FIG. 2, the spring element 48 is a cylindrically wound helical spring.

In this case, the spring element 48 is guided in a sleeve 52, which is fastened to the base body 50 coaxially in relation to the central axis.

The spring element 48 therefore runs in the interior of the sleeve 52.

In this case, the sleeve 52 comprises a first section 54 having a first inner diameter D1. In this case, the first section 54 is provided on a side of the sleeve 32 that faces away from the first component 30 and the second component 32.

In addition, the sleeve 52 comprises a second section 56 having a second inner diameter D2. The second inner diameter D2 in this case is larger than the first inner diameter D1. A transition between the first section 54 and the second section 56 comprises a chamfer. In addition, a chamfer is provided at the end of the second section 56 that faces the first component 30 and the second component 32.

As a result, the spring element 48 has a greater radial free play in the region of the second section 56 than in the first section 54.

In the region of the second section 56, it is therefore possible to compensate for a possibly not perfectly coaxial arrangement of the first component 30, without the spring element 48 in this case necessarily touching the sleeve 52.

In the example in accordance with FIG. 2, the receiving channel 40 further comprises a clearance 58.

In this case, the clearance 58 is designed as a free space 60 for the contactless reception of an end section of the first component 30, wherein the end section faces the second component 32.

In the present case, this free space 60 is formed by means of a cylindrical section 61 of the receiving channel 40. This lies on the side of the second contact surface 44 that faces away from the first component 30.

The free space 60 can be implemented, by way of example, as a bore.

In other words, the receiving channel 40 is of sufficient length on the side that faces away from the first component 30 that a tip of the conical contact section 34 can be received therein without touching the second component 32.

On the side of the second component 32, contact between the first component 30 and the second component 32 therefore takes place exclusively via the section of the side surface 42 that is embodied as the second contact surface 44.

Along the central axis A, the spring element 48 generates a spring loading between the first component 30 and the second component 32. Due to the fact that the first contact surface 36 and the second contact surface 44 extend obliquely in relation to the central axis, a force amplification results with regard to a contact force that acts in each case perpendicularly between the first contact surface 36 and the second contact surface 44. In terms of magnitude, the contact force is therefore greater than the force resulting from the spring loading. In this manner, reliable contacting and thus a high signal quality are ensured.

As already explained, the second contact surface 44 has the shape of a shell surface of a truncated cone. The first component 30 and the second component 32 thus lie against one another both in the axial direction and in the radial direction.

The truncated cone can have a tip angle of 60 to 120 degrees. In preferred variants, the truncated cone has a tip angle of 80 to 100 degrees, for example 90 degrees.

The same applies to the truncated cone, the shell surface of which forms the first contact surface 36.

In this case, a purely axial abutment of the first component 30 against the second component 32 is ruled out by means of the clearance 58. In other words, due to the geometric design of the first component 30 and the second component 32, it is impossible for them to bear against one another in a purely axial manner.

This results in a particularly efficient and reliable contact between the first component 30 and the second component 32. Starting from the connection assembly 28, a current can thus be introduced with great reliability into the drive shaft 12 and thus into the saw blade 14 via the spring element 48, the first component 30 and the second component 32. In the same way, the drive shaft 12 and thus the saw blade 14 can be electrically energised.

FIG. 3 illustrates an alternative embodiment of the electrical rotary feedthrough 26.

In the following, in this case only the differences with respect to the embodiment already explained will be discussed. Identical or mutually corresponding elements are provided with the same reference signs.

The embodiment in accordance with FIG. 3 differs essentially in two aspects.

In accordance with a first aspect, the spring element 48 is now in the form of a conically wound helical spring. As a result, the spring element 48 can be designed to be comparatively compact along the central axis A, in other words in the axial direction, in the case of identical spring forces.

In addition, the sleeve 52 is now provided with a constant inner diameter.

However, the fact that the spring element 48 now has a larger diameter in a region that faces away from the first component 30 and the second component 32 than in a region that faces the first component 30 and the second component 32 also results in the embodiment in accordance with FIG. 3 in the effect that the spring element 48 is guided through the sleeve on the one hand, but on the other hand a comparatively large radial free space is provided for the spring element 48 in a region adjacent to the first component 30 and the second component 32.

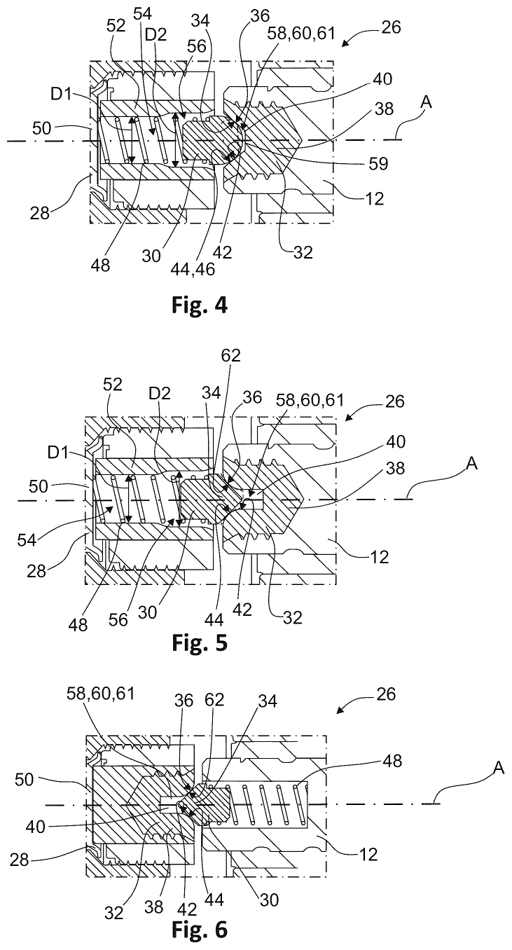

A further embodiment of the rotary feedthrough 26 is apparent in FIG. 4.

In the following, again, only the differences with respect to the embodiments already explained will be explained. Identical or mutually corresponding elements are provided with the same reference signs.

The embodiment in FIG. 4 differs from the embodiment in FIG. 2 in that the contact section 34 is no longer conical in shape, but has a spherical section-shaped or spherical end. The first contact surface 36 is thus formed by means of a section of a spherical surface.

Moreover, in FIG. 4 dashed lines illustrate a further example in which the first contact surface 36 is formed by means of a convex section of an outer surface of a torus.

In more general terms, the first contact surface 36 is thus a convex curved surface.

In the embodiment in accordance with FIG. 4, the clearance 58 results in that the radius of the first contact surface 36 and the angle at which the second contact surface 44 is inclined in relation to the central axis A are matched to one another in such a way that the first contact surface 36, in other words the first component 30, always has a certain distance, which is greater than zero, from an end of the receiving channel 40 that faces away from the first component 30.

In this context, the clearance 58 can be regarded as a feature of the receiving channel 40 and thus of the second component 32. From this point of view, the clearance 58 is regarded as a section of the receiving channel 40.

Alternatively, the clearance 58 can be viewed as a feature of the contact section 34. From this point of view, the clearance 58 is a feature of the first component 30. In this perspective, the clearance 58 is formed by means of a void 59, in other words a region without material of the first component 30. In the present case, those regions of the contact section 34 that have been removed in the course of production in order to produce the first contact surface 36, or have not been provided in the first place, are to be regarded as a void 59.

In addition, reference can be made to the explanations regarding the embodiment in accordance with FIG. 2.

Moreover, it is understood that the embodiments in accordance with FIG. 3 and FIG. 4 can also be combined. Accordingly, the rotary feedthrough 26 in accordance with FIG. 4 can alternatively be equipped with a spring element 48 in accordance with FIG. 3 and also a sleeve 52 in accordance with FIG. 3.

A further embodiment of the rotary feedthrough 26 is illustrated in FIG. 5.

Again, only the differences with respect to the embodiments already described will be explained. Identical or mutually corresponding elements are provided with the same reference signs.

In the embodiment in accordance with FIG. 5, the first component 30, the spring element 48 and the sleeve 52 correspond to the embodiment in accordance with FIG. 1.

However, the receiving channel 40 is now shaped differently.

In contrast to the embodiments explained above, the side surface 42 now comprises a convex curved surface section 62, which is arranged at the inlet of the receiving channel 40, in other words at the end of the receiving channel 40 that faces the first component 30. As before, the convex curved surface section 62 is rotationally symmetrical in relation to the central axis A.

In this case, the convex curved surface section 62 forms the second contact surface 44. Accordingly, in the embodiment in accordance with FIG. 5, the second contact surface 44 can also be referred to as trumpet-shaped.

In a manner analogous to the embodiments in accordance with FIGS. 2 and 3, the clearance 58 is designed as a cylindrical section 61 of the receiving channel 40, which adjoins the convex curved surface section 62 on a side that faces away from the first component 30.

It is understood that the embodiment in accordance with FIG. 5 can also be combined with the embodiments described above. In particular, in the embodiment in accordance with FIG. 5, a first component 30 in accordance with the embodiment in FIG. 4 can be provided as an alternative.

As a further alternative, in FIG. 5 dashed lines illustrate a contact surface 34 which is in the form of a concave section of an outer surface of a torus.

In more general terms, the first contact surface 36 can thus be a concave or convex curved surface.

Alternatively or additionally, it is possible for the spring element 48 and/or the sleeve 52 of the embodiment in accordance with FIG. 5 to be replaced by the spring element 48 and/or the sleeve 52 of the embodiment in FIG. 3.

FIG. 6 illustrates a further embodiment of the rotary feedthrough 26.

Again, only the differences with respect to the above embodiments are explained. Identical or mutually corresponding elements are provided with the same reference signs.

The embodiment in accordance with FIG. 6 is essentially the kinematic reversal of the embodiment in accordance with FIG. 5.

In this case, in the embodiment in accordance with FIG. 6, merely in lieu of the sleeve 52 having two sections of different inner diameters D1, D2, the spring element 48 is guided in a bore having a constant diameter, which is provided on the drive shaft 12 along the central axis A.

In other words, the first component 30 is now arranged on the drive shaft 12 and is thus rotatable.

The second component 32 is fixed and is connected to the connection assembly 28.

Even if only the embodiment in accordance with FIG. 6 has been described as a kinematic reversal of the embodiment in accordance with FIG. 5, it is understood that, of course, the embodiments in FIGS. 2, 3 and 4 also function in a kinematically reversed manner. In the embodiments in accordance with FIGS. 2, 3 and 4, the first component can thus also be arranged on the drive shaft 12 and the second component 32 on the connection assembly 28.

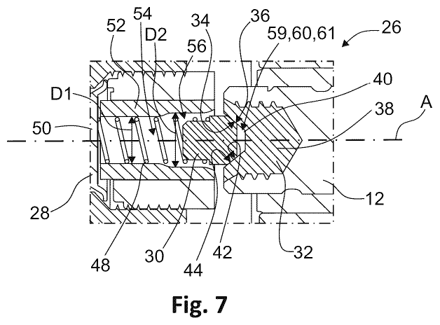

An additional embodiment is apparent in FIG. 7.

Again, only the differences with respect to the embodiments already explained will be discussed. Identical or mutually corresponding elements are provided with the same reference signs.

In contrast to the embodiments already explained, the contact section 34 of the first component 30 is now in the form of a truncated cone. This means that, starting from those embodiments in which the contact section is conical, the tip of the cone has been flattened. In this case, the flattening represents a clearance 58 or a void 59.

The receiving channel 40 of the second component 32 is now embodied as conical or conical in shape.

However, due to the flattening, in other words the clearance 58, it is possible to rule out a purely axial contact between the first contact surface 36 and the second contact surface 44.

It is understood that the embodiments in FIG. 7 also function in a kinematically reversed manner. It is also understood that the spring element 48 of the embodiment in accordance with FIG. 7 can be replaced by a spring element 48 in accordance with the embodiment in FIG. 3. The sleeve 52 of the embodiment in FIG. 7 can alternatively be designed with a constant inner diameter.

In all the aforementioned embodiments, the insert 38 is produced from graphite wool.

In order to produce the insert 38 and in particular the receiving channel 40, a piece of graphite wool is pressed into the end section of the drive shaft 12 in a first step. For this purpose, a recess having an internal thread is provided in the end section. The piece of graphite wool therefore does not yet have a receiving channel 40.

In a second step, a tool whose outer contour corresponds to the inner contour of the receiving channel 40 to be produced is pressed into the graphite wool. In this manner, the graphite wool is locally displaced and/or deformed, resulting in the receiving channel 40 having the desired geometry.

It is also possible for the first and second steps to be carried out together, in other words for the inner contour of the receiving channel 40 to be introduced into the graphite wool directly when a piece of graphite wool is pressed in.

### LIST OF REFERENCE SIGNS

10 Sawing apparatus
12 Drive shaft
14 Saw blade
16 Base part
18 Emergency braking unit
20 Braking apparatus
22 Sensor apparatus
24 Control unit
26 Electrical rotary feedthrough
28 Connection assembly
30 First component of the electrical rotary feedthrough
32 Second component of the electrical rotary feedthrough
34 Contact section
36 First contact surface
38 Insert
40 Receiving channel
42 Side surface
44 Second contact surface
46 Surface section in the shape of a truncated cone shell
48 Spring element
50 Base body
52 Sleeve
54 First section of the sleeve
56 Second section of the sleeve
58 Clearance
59 Void
60 Free space
61 Cylindrical section of the receiving channel
62 Convex curved surface section
A Central axis
D1 First inner diameter
D2 Second inner diameter

1. A sawing apparatus, comprising:
a drive shaft that is rotatable about a central axis for rotationally driving a saw blade, a base part on which the drive shaft is rotatably mounted, and an electrical rotary feedthrough for the electrically conductive connection of the drive shaft to a connection assembly that is fastened to the base part,
wherein the electrical rotary feedthrough comprises a first component, which is arranged coaxially in relation to the central axis, and a second component that is arranged coaxially in relation to the central axis,
wherein the first component comprises a contact section that tapers in the direction of the second component and along the central axis and a shell surface of the contact section forms a first contact surface,
wherein the second component comprises a receiving channel that extends along the central axis and a side surface of the receiving channel forms a second contact surface, wherein the first contact surface lies against the second contact surface at least in sections, and
wherein the receiving channel and/or the tapering contact section comprises a clearance for ruling out a purely axial abutment of the first component against the second component.

2. The sawing apparatus according to claim 1, wherein the side surface comprises a surface section in the shape of a truncated cone shell, and the surface section in the shape of a truncated cone shell forms the second contact surface.

3. The sawing apparatus according to claim 1, wherein the side surface comprises a convex curved surface section and the convex curved surface section forms the second contact surface.

4. The sawing apparatus according to claim 1, wherein the tapering contact section and/or the receiving channel are rotationally symmetrical at least in sections in relation to the central axis.

5. The sawing apparatus according to claim 1, wherein the first component and the second component are spring-loaded against one another by means of a spring element.

6. The sawing apparatus according to claim 5, wherein the spring element comprises a cylindrical or conically wound helical spring.

7. The sawing apparatus according to claim 5, wherein the spring element is guided in a sleeve.

8. The sawing apparatus according to claim 7, wherein the sleeve comprises a first section having a first inner diameter and a second section having a second inner diameter, wherein the second inner diameter is larger than the first inner diameter and the second section faces the first component or the second component to be acted upon.

9. The sawing apparatus according to claim 1, wherein the clearance is formed by means of a free space for the contactless reception of an end section of the first component that faces the second component.

10. The sawing apparatus according to claim 9, wherein the free space is formed by means of a cylindrical section of the receiving channel, which lies on a side of the second contact surface that faces away from the first component.

11. The sawing apparatus according to claim 1, wherein the clearance is formed by means of a void of an end section of the first component that faces the second component.

12. The sawing apparatus according to claim 1, wherein the second component is formed by means of an end section of the drive shaft and the receiving channel is arranged in the drive shaft, or
wherein the second component is formed by means of an element of the connection assembly, and the receiving channel is arranged in the element of the connection assembly.

13. The sawing apparatus according to claim 1, wherein the second component comprises an insert and the receiving channel is arranged in the insert.

14. The sawing apparatus according to claim 12, wherein the insert is connected to the end section of the drive shaft or the element of the connection assembly via a positive-locking connection that acts along the central axis.

15. An electrical rotary feedthrough for a sawing apparatus according to claim 1, wherein the electrical rotary feedthrough can rotate about a central axis, to a connection assembly that is fixed relative to the drive shaft and comprises a first component and a second component that are arranged coaxially in relation to a central axis,
wherein the first component comprises a contact section that tapers in the direction of the second component and along the central axis and the shell surface of said contact section forms a first contact surface,
wherein the second component comprises a receiving channel that extends along the central axis and the side surface of the receiving channel forms a second contact surface,
wherein the first contact surface lies against the second contact surface at least in sections, and
wherein the receiving channel and/or the contact section comprises a clearance for ruling out a purely axial abutment of the first component against the second component.
